(19) United States
(12) Patent Application Publication
(10) Pub. No.: US 2011/0137460 A1
(43) Pub. Date: Jun. 9, 2011

(54) TASK IMPLEMENTATION METHOD BASED ON BEHAVIOR IN ROBOT SYSTEM

(75) Inventors: Moo-Hun LEE, Daejeon (KR); Kang-Woo Lee, Daejeon (KR); Hyun Kim, Daejeon (KR)

(73) Assignee: Electronics and Telecommunications Research Institute, Daejeon (KR)

(21) Appl. No.: 12/961,548

(22) Filed: Dec. 7, 2010

(30) Foreign Application Priority Data
Dec. 9, 2009 (KR) 10-2009-0121666

(51) Int. Cl. B25J 9/00

(52) U.S. Cl. 700/250

(57) ABSTRACT

The present invention relates to a task implementation method based on a behavior in a robot system. The task implementation method based on a behavior in a robot system includes: implementing one or more basic behaviors by using one or more components among a plurality of components; implementing an extensible behavior by using the one or more basic behaviors; and implementing an extended behavior by using the extensible behavior.

### CROSS REFERENCE TO RELATED APPLICATIONS

This application claims priority to Korean Patent Application No. 10-2009-0121666 filed on Dec. 9, 2009, the entire contents of which is herein incorporated by reference.

### BACKGROUND OF THE INVENTION

1. Field of the Invention

The present invention relates to a control structure of a robot system, and more particularly, to a task implementation method based on a behavior in a robot system.

2. Description of the Related Art

A robot system requires a lot of hardware and software modules in order to provide a user's desired service in various environments and requires an efficient control structure in order to organically operate the hardware and software modules.

Further, a known robot system performs a simple task, for example, only an application program of a robot system, while a modern intelligent robot provides various services under a complicated environment and should successively perform a complicated task in order to provide various services.

As such, improvement of a software control structure is required in addition to hardware improvement for the robot system to perform various and complicated tasks. As a result, the control structure of the robot system has been actively researched.

The control structure of the known robot system adopts an SPA structure based on a sense, a plan, and an act. The SPA structure sequentially controls the robot system in accordance with the control structure classified into three parts of a sense, a plan, and an act.

For example, in sensing the SPA structure, all information is collected from a sensor, a world model is generated based on information collected and a plan for performance is established in the plan, and the act is performed in accordance with a command transferred in the plan.

The SPA structure can be optimized for a complicated task, but the SPA structure depends on a low response time depending on system complexity and an external environment, that is, a hardware configuration of the robot system.

In order to solve the problem, although an act based control structure based on a subsumption architecture has been proposed, the act based control structure cannot perform the complicated task.

### SUMMARY OF THE INVENTION

It is an object of the present invention to provide a task implementation method based on a behavior in a robot system on the basis of an extensible and reusable behavior without depending on a hardware configuration of the robot system while a task of the robot system based on the behavior is implemented.

According to an exemplary embodiment of the present invention, there is provided a task implementation method based on a behavior in a robot system that includes: implementing at least one basic behavior by using at least one component among a plurality of components; implementing an extensible behavior by using the at least one basic behavior; and implementing an extended behavior by using the extensible behavior.

According to another embodiment of the present invention, there is provided a task implementation method based on a behavior in a robot system that includes: extracting at least one behavior corresponding to the task to be developed among the plurality of behaviors of the robot system implemented by the first developer; and implementing the task of the robot system by reconfiguring the at least one extracted behavior.

A task implementation method based on a behavior in a robot system according to exemplary embodiments of the present invention can shorten a development time of a complicated task and efficiently perform maintenance by adding an extensible behavior reusable and extensible to a behavior layer while an application program, that is, a task of a robot system is implemented based on a behavior of a robot.

Further, it is possible to implement the task of the robot system by a future developer's reusing the previously implemented behavior layer.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram showing a control layer structure of a robot system according to an exemplary embodiment of the present invention;

FIG. 2 is a flowchart implementing a task of a robot according to an exemplary embodiment of the present invention;

FIG. 3 is a diagram showing one example of a control layer structure of a robot including a task implemented in accordance with a flowchart of FIG. 2;

FIG. 4 is a conceptual diagram of an extensible behavior of FIG. 3;

FIG. 5 is a conceptual diagram of an extended behavior of FIG. 3;

FIG. 6 is a flowchart implementing a task of a robot according to another embodiment of the present invention; and

FIG. 7 is a flowchart of a control method of a robot using a task implemented by FIGS. 1 to 6.

### DETAILED DESCRIPTION OF THE PREFERRED EMBODIMENTS

The accompanying drawings illustrating exemplary embodiments of the present invention and contents described in the accompanying drawings should be referenced in order to fully appreciate operational advantages of the present invention and objects achieved by the embodiments of the present invention.

Hereinafter, the present invention will be described in detail by describing exemplary embodiments of the present invention with reference to the accompanying drawings. Like elements refer to like reference numerals shown in the drawings.

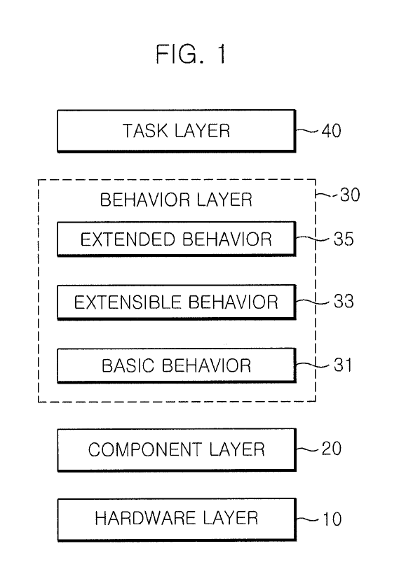

FIG. 1 is a diagram showing a control layer structure of a robot system according to an exemplary embodiment of the present invention.

Referring to FIG. 1, a control layer structure of a robot system (hereinafter, referred to as a ‘robot’) may include a hardware layer 10, a component layer 20, a behavior layer 30, and task (alternately, application program) layer 40.

The hardware layer 10 may be constituted by a plurality of hardware of the robot system (hereinafter, referred to as ‘robot’). For example, the hardware layer 10 may include a plurality of hardware constituting the robot, which includes a wheel (alternately, a leg) for moving the robot, a robot arm, a camera, sensors including a touch sensor and an ultrasonic sensor, etc.

The component layer 20 may be constituted by a plurality of components for controlling operations of the plurality of hardware respectively.

For example, embedded software or firm ware is implemented (loaded) in each of the plurality of hardware and the plurality of components of the component layer 20 may be implemented by using an application program interface (API) provided from each of the plurality of hardware.

Each of the plurality of components may be implemented by being programmed by a component developer and may implemented dependently to the plurality of hardware of the robot.

The behavior layer 30 may be constituted by a basic behavior 31, an extensible behavior 33, and an extended behavior 35.

For example, the developer may implement a plurality of behaviors of the robot by using one or more components among the plurality of components that are already implemented.

In this case, the developer may implement the basic behavior 31 of the behavior layer 30 by using one or more components, implement the extensible behavior 33 by using the implemented basic behavior 31 or combining one or more components with the implemented basic behavior 31, and implement the extended behavior 35 by the extensible behavior 33 or combining the basic behavior 31 or one or more components with the extensible behavior 33.

Herein, the basic behavior 31 as the most basic behavior of the behavior layer 30 does not need to be extended any longer. The basic behavior 31 may be implemented by using one or more components through device abstraction.

Further, the basic behavior 31 may be implemented by using the basic behavior that is previously implementing by using one or more components. That is, the developer may implement a new basic behavior by combining one or more already implemented basic behaviors.

The extensible behavior 33 may be implemented differently depending on an implementation intention of the developer or a configuration of the robot. The extensible behavior 33 preferably has extensibility for the future developer to easily develop the task of the robot, for example, the robot application program. The extensibility of the extensible behavior 33 will be described in detail with reference to figures afterwards.

The extended behavior 35 may be implemented by the extensible behavior 33. According to the embodiment, the extended behavior 35 may be implemented by the combination of the extensible behavior 33 and other behaviors, that is, one or more basic behaviors 31 or the combination of the extensible behavior 33 and one or more components.

The task layer 40 may be constituted by the task of the robot, that is, the robot application program implemented by the plurality of behaviors of the behavior layer 30 such as the basic behavior 31, the extensible behavior 33, and the extended behavior 35.

The task of the task layer 40 may be variously implemented depending on an intention of the developer and various operations performed by the robot in accordance with a user's command may be implemented by one or more tasks.

The task may be implemented by the plurality of behaviors of the behavior layer 30 and as a result, the developer may implement the task without considering hardware characteristics of the robot.

The plurality of components of the component layer 20, the plurality of behaviors of the behavior layer 30, and the one or more tasks of the task layer 40 may be implemented by using various programming languages, such as C⁺⁺, Java, etc.

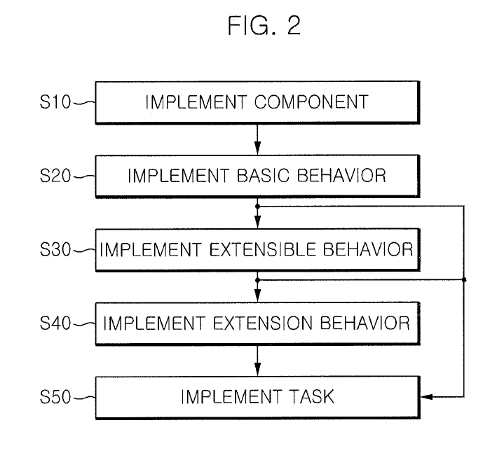

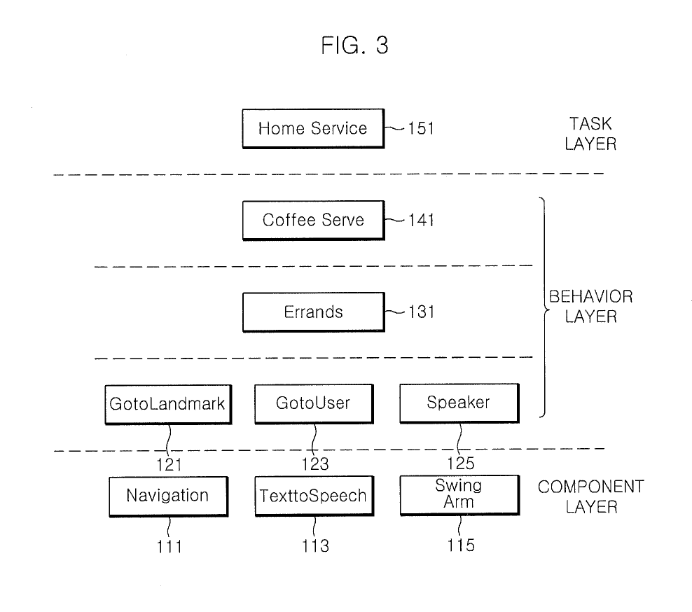

FIG. 2 is a flowchart implementing a task of a robot according to an exemplary embodiment of the present invention and FIG. 3 is a diagram showing one example of a control layer structure of a robot including a task implemented in accordance with a flowchart of FIG. 2.

Referring to FIGS. 1 to 3, a developer may implement a plurality of components by using a plurality of hardware of a hardware layer 10 (S10).

For example, the developer may implement a navigation component 111 driving and controlling travelling from each of the plurality of hardware of the robot.

Further, the developer may implement a test-to-speech (hereinafter, referred to as ‘TTS’) component 113 converting a text to speech from each of the plurality of hardware of the robot.

Further, the developer may implement a swing arm component 115 controlling movement of a robot arm by using each of the plurality of hardware of the robot.

That is, the developer may drive and control a physical actuator of the robot or sensor by implementing the plurality of components.

Herein, the developer may be a component developer implementing only the plurality of components or an application developer implementing a plurality of behaviors of a behavior layer 30 or a task of a task layer 40.

In the embodiment, as one example, a case in which the developer develops the plurality of behaviors and one or more task in addition to the plurality of components will be described. However, the present invention is not limited thereto and a developer who implements the plurality of components and a developer who implements the plurality of behaviors and one or more tasks may be differently configured.

When the plurality of components are implemented, the developer may implement the plurality of behaviors of the behavior layer 30 by using one or more components among the plurality of implemented components.

The developer may implement a basic behavior 31 of the robot by using one or more components (S20).

For example, the developer may implement a behavior for moving the robot from the implemented navigation component 111 to a predetermined position, i.e., a GotoLandmark behavior 121.

Further, the developer may implement a speaker behavior 125 in which the robot outputs voice by using the implemented TTS component 113.

Further, the developer may implement another basic behavior, i.e., a GotoUser behavior 123 for moving the robot to a user's position from the implemented basic behavior, i.e., the GotoLandmark behavior 121.

When one or more basic behaviors 31 are implemented by using one or more components, the developer may implement an extensible behavior 33 of the robot by using one or more basic behavior 31 (S30).

The extensible behavior 33 may be implemented to have extensibility as described above and may be implemented differently depending on the developer or a type of the robot.

For example, the developer may implement an Errands behavior 31 in which the robot can perform errands by using the implemented GotoLandmark behavior 121 or the GotoUser behavior 123.

The Errands behavior 131 may be extended by various behaviors by the developer as a behavior having extensibility.

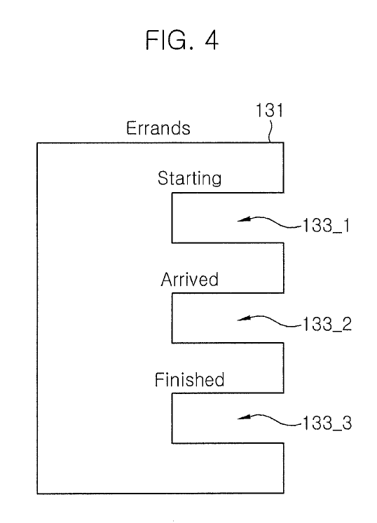

FIG. 4 is a conceptual diagram of an extensible behavior of FIG. 3.

Referring to FIGS. 3 and 4, the developer implements the Errands behavior 131 extensible from one or more basic behaviors 31 and may designate one or more extension points 133_1, 1332, and 133_3 to the Errands behavior 131 for extensibility.

For example, the developer may designate the first extension point 133_1 at a starting time of the Errands behavior 131, that is, at a time before the robot starts the Errands behavior 131.

Further, the developer may designate the second extension point 133_2 at an intermediate time of the Errands behavior 131, that is, at a time before the robot starts a user's command after arriving at a designated position by performing the Errands behavior 131.

Further, the developer may designate the third extension point 133_3 at a finished time of the Errands behavior 131, that is, at a time after the robot returns to a user's position after performing the Errands behavior 131.

Referring back to FIGS. 1 to 3, when the plurality of extension points 133_1, 133_2, and 133_3 are designated to the Errands behavior 131, the developer may implement an extended behavior 35 by adding an extension element to each of the extension points 133_1, 133_2, and 133_3 (S40).

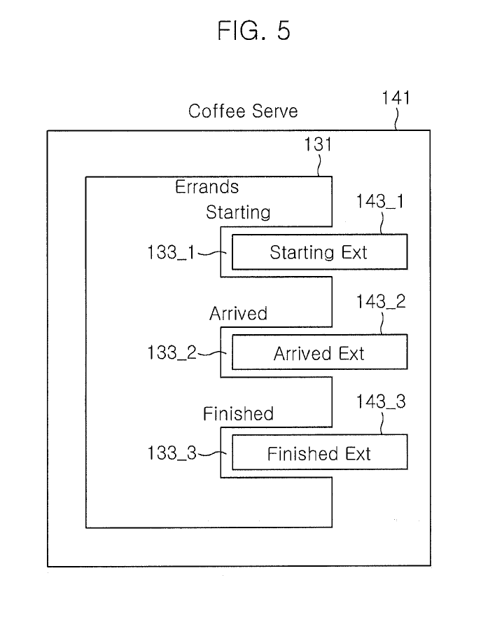

FIG. 5 is a conceptual diagram of an extended behavior of FIG. 3.

Referring to FIGS. 3 and 5, the developer may implement the extended behavior 35 by adding a first extension 143_1 to a third extension 143_3 to the first extension point 133_1 to the third extension point 133_3 of the Errands behavior 131, respectively.

Herein, the first extension 143_1 added to the first extension point 133_1 of the Errands behavior 131 by the developer may include user command information and user's position information.

Further, the second extension 143_2 added to the second extension point 133_2 of the Errands behavior 131 by the developer may include robot operation information at a designated position.

Further, the third extension 143_3 added to the third extension point 133_3 of the Errands behavior 131 by the developer may include robot operation information at a user's position.

That is, the developer may implement a serving operation of the robot, i.e., a coffee serve behavior 141 by adding the first extension 143_1 to the third extension 143_3 to the first extension point 133_1 to the third extension point 133_3 of the extensible Errands behavior 131, respectively.

Therefore, the robot may move to a designated position, that is, a location where coffee is positioned and perform a serving operation to the user while taking a cup containing coffee in accordance with a coffee Errands command from the user.

Meanwhile, the first extension 143_1 to third extension 143_3 may be implemented from the combination of the plurality of components such as the swing-arm component 115 and the navigation component 111 and one or more basic behaviors 31, i.e., the speaker behavior 125 that are implemented by the developer.

In the embodiment, as one example, a case in which the developer implements the coffee serve behavior 141 extended from the Errands behavior 131 is described, but the present invention is not limited thereto.

Referring back to FIGS. 1 to 3, when the extended behavior 35 is implemented by adding the extension, the developer may implement a task, i.e., an application program of the robot by using the extended behavior 35 (S50).

In the embodiment, the developer may implement a home service task 151 by using the extended behavior 35, i.e., the coffee serve behavior 141.

One task, i.e., the home service task 151 may include one or more extended behaviors 35. That is, the home service task 151 of the present invention may include various extended behaviors extended from the Errands behavior 131 by the developer in addition to the coffee serve behavior 141 shown in FIG. 3.

The developer implements the home service task 151 and may implement the home service task 151 by combining the extensible behavior 33 and the basic behavior 31 in addition to the extended behavior 35.

Meanwhile, while the plurality of components of the component layer 20 or the plurality of behaviors of the behavior layer 30 are implemented by a first developer (alternately, a previous developer), the developer may implement the task of the robot by reconfiguring the plurality of components or the plurality of behaviors that are implemented.

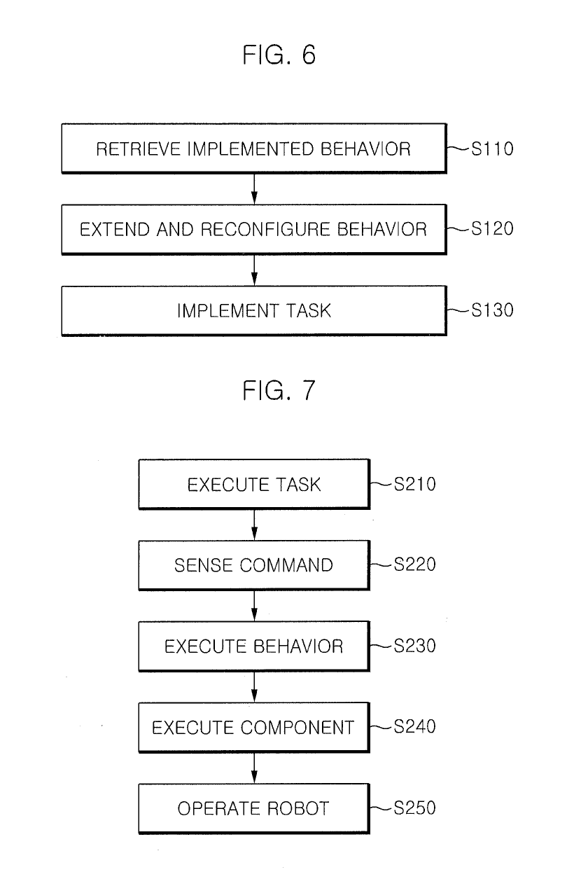

FIG. 6 is a flowchart implementing a task of a robot according to another embodiment of the present invention.

Referring to FIGS. 1, 3, and 6, when the first developer implements the plurality of components or the plurality of behaviors, a future developer (hereinafter, referred to as a ‘developer’) may extract one or more components or behaviors suitable for the task of the robot to be developed by retrieving the plurality of components or the behaviors that are previously implemented (S110).

The developer may reconfigure one or more components or one or ore behaviors that are extracted and extend and reconfigure the extensible behavior (S120).

When the first developer already implements the plurality of components, the developer may implement one or more basic behaviors 31 of the robot by reconfiguration to combine one or more components among the plurality of components.

For example, the developer may implement the GotoLandmark 121 from the navigation component 111 that is already implemented and implement the speaker behavior 125 from the TTS component 113. Further, the developer may implement the GotoUser behavior 123 by using the GotoLandmark 121.

Subsequently, the developer may implement the extensible behavior 33 and the extended behavior 35 by using the one or more implemented basic behavior 31 as described above.

Further, when the first developer already implements the plurality of components and one or more basic behaviors 31, the developer may implement the extensible behavior 33 of the robot through reconfiguration to combine one or more components or one or more basic behaviors 31 among the plurality of components.

For example, the developer may implement the Errands behavior 131 by combining the GotoLandmark behavior 121 and the GotoUser behavior 123 among the GotoLandmark behavior 121, the GotoUser behavior 123, and the speaker behavior 125 that are already implemented.

Subsequently, the developer may implement the extended behavior 35 by using the implemented extensible behavior 33 as described above.

Further, when the first developer already implements the plurality of components and one or more basic behaviors 31 and the extensible behavior 33, the developer may implement the extended behavior 35 of the robot through reconfiguration to combine one or more components or one or more basic behaviors 31 or extensible behaviors 33 among the plurality of components.

For example, the developer may implement a behavior extended from the already implemented Errands behavior 131, i.e., the coffee serve behavior 141. The coffee serve behavior 141 may be implemented by adding the extension to one or more extension points of the Errands behavior 131 as described above.

The developer may implement the task by using the plurality of behaviors of the behavior layer 30 after implementing the behavior layer 30 by using the already implemented component or behavior (S130).

FIG. 7 is a flowchart of a control method of a robot using a task implemented by FIGS. 1 to 6. In the embodiment, for convenience of description, a case in which the robot performs a coffee serve command from the user is described as an example and as a result, the control method will be described with reference to FIG. 3 in addition to FIG. 7.

Referring to FIGS. 1, 3, and 7, a robot system may execute the home service task 151 and the home service task 151 may wait to sense the user's command (S210).

When the user transmits a coffee errands command to the robot by using voice or text, the robot may sense the coffee errands command of the user throughout the task (S220).

After the robot senses the user's command, the robot may execute the plurality of behaviors of the behavior layer 30 such as the basic behavior 31, the extensible behavior 33, and the extended behavior 35 by the home service task 151 (S230).

Subsequently, the plurality of components of the component layer 20 are executed by the plurality of behaviors (S240) and as a result, the robot may perform the coffee Errands command of the user by moving to the location where coffee is positioned, and performing the serving operation to the user while taking the cup containing coffee (S250).

Although contents of the present invention are described with reference to exemplary embodiments shown in the drawings, the contents are just exemplary and it will be appreciated by those skilled in the art that various modification and other equivalent embodiments will be made. Accordingly, the scope of the present invention must be determined by the spirit of the appended claims.

What is claimed is:

1. A task implementation method based on a behavior in a robot system, comprising:
implementing at least one basic behavior by using at least one component among a plurality of components;
implementing an extensible behavior by using the at least one basic behavior; and
implementing an extended behavior by using the extensible behavior.

2. The task implementation method of claim 1, further comprising implementing the task of the robot system by using the extended behavior.

3. The task implementation method of claim 1, further comprising implementing the task of the robot system by combining the basic behavior, the extensible behavior, and the extended behavior.

4. The task implementation method of claim 1, wherein the implementing the extensible behavior implements the extensible behavior by using the at least one basic behavior and designates at least one extension point for the extensible behavior.

5. The task implementation method of claim 4, wherein the implementing the extended behavior adds an extension to the at least one extension point of the extensible behavior.

6. The task implementation method of claim 5, wherein the extension is implemented by using the plurality of components or the at least one basic behavior.

7. The task implementation method of claim 1, wherein each of the plurality of components is implemented to control each of a plurality of hardwares of the robot system, respectively.

8. A task implementation method based on a behavior in a robot system, comprising:
extracting at least one behavior corresponding to the task to be developed among a plurality of behaviors of the robot system implemented by a first developer; and
implementing the task of the robot system by reconfiguring the extracted behavior.

9. The task implementation method of claim 8, wherein the plurality of behaviors include at least one basic behavior implemented by using a plurality of components, and
the implementing the task includes:
implementing an extensible behavior by using the at least one basic behavior;
implementing an extended behavior by using the extensible behavior; and
extracting at least one behavior among the basic behavior, the extensible behavior, and the extended behavior, and implementing the task using the extracted at least one behavior.

10. The task implementation method of claim 9, wherein the implementing the extensible behavior implements the extensible behavior by using the at least one basic behavior and designates at least one extension point for the extensible behavior.

11. The task implementation method of claim 10, wherein the implementing the extended behavior adds an extension to the at least one extension point of the extensible behavior.

12. The task implementation method of claim 11, wherein the extension is implemented by using the plurality of components implemented by the first developer or the at least one basic behavior.

13. The task implementation method of claim 8, wherein the plurality of behaviors include at least one basic behavior implemented by the plurality of components and the extensible behavior implemented by using the at least one basic behavior, and
the implementing the task includes:
implementing the extended behavior by using the extensible behavior; and
implementing the task by extracting at least one behavior among the basic behavior, the extensible behavior, and the extended behavior.

14. The task implementation method of claim 13, wherein the extensible behavior includes at least one extension point, and
the implementing the extended behavior adds the extension to the at least one extension point of the extensible behavior.

15. The task implementation method of claim 14, wherein the extension is implemented by using the plurality of components implemented by the first developer or the at least one basic behavior.
